(19) United States
(12) Patent Application Publication
(10) Pub. No.: US 2025/0209247 A1
(43) Pub. Date: Jun. 26, 2025

(54) LAYOUT DESIGNING METHOD AND INTEGRATED CIRCUIT DEVICE MANUFACTURING METHOD USING THE SAME

(71) Applicant: SAMSUNG ELECTRONICS CO., LTD., Suwon-si (KR)

(72) Inventors: Ingyun Chung, Suwon-si (KR); Dongjin Park, Suwon-si (KR)

(21) Appl. No.: 18/981,969

(22) Filed: Dec. 16, 2024

(30) Foreign Application Priority Data
Dec. 22, 2023 (KR) 10-2023-0190338

(51) Int. Cl. G06F 30/392

(52) U.S. Cl. CPC G06F 30/392

(57) ABSTRACT

A method for layout designing, includes preparing a first layout, forming a test pattern based on the first layout generating first error data based on the first layout and the test pattern, wherein the first error data includes a value of misalignment of the test pattern from a reference position, normalizing coordinate data of the first layout to obtain first coordinate data, generating first stress distribution data by performing finite element analysis simulation, wherein a boundary condition of the structural analysis mesh model is determined based on the first coordinate data, generating an error prediction machine learning model based on the first error data, the first coordinate data, and the first stress distribution data, predicting second error data of a second layout, and generating a final layout based on the second error data.

### CROSS-REFERENCE TO RELATED APPLICATION

This U.S. non-provisional patent application claims priority under 35 U.S.C. § 119 to Korean Patent Application No. 10-2023-0190338, filed on Dec. 22, 2023, in the Korean Intellectual Property Office, the disclosure of which is incorporated by reference herein in its entirety.

### BACKGROUND

The inventive concept relates to a layout designing method and an integrated circuit device manufacturing method using the same.

In a semiconductor process, a photolithography process using a mask may be performed to form a pattern on a semiconductor substrate such as a wafer. For example, a mask may be referred to as a pattern transfer artifact in which a pattern shape of an opaque material is formed on a transparent base material. During a mask manufacturing process, a target circuit and a layout for the target circuit are designed. Then, mask design data obtained through optical proximity correction (OPC) is transmitted as mask tape-out (MTO) design data. Then, mask data preparation (MDP) is performed based on the MTO design data, and a pre-process (front end of line (FEOL)) such as an exposure process and a post-process (back end of line (BEOL)) such as a defect inspection process are performed to manufacture a mask.

### SUMMARY

A method for layout designing, including preparing a first layout, forming a test pattern based on the first layout generating first error data based on the first layout and the test pattern, wherein the first error data includes a value of misalignment of the test pattern from a reference position, normalizing coordinate data of the first layout to obtain first coordinate data, generating, using a structural analysis mesh model, first stress distribution data by performing finite element analysis simulation, wherein a boundary condition of the structural analysis mesh model is determined based on the first coordinate data, generating an error prediction machine learning model based on the first error data, the first coordinate data, and the first stress distribution data, predicting, using the error prediction machine learning model, second error data of a second layout, wherein the second layout is different from the first layout, and generating a final layout based on the second error data.

A method for layout designing, including obtaining data on a test pattern formed based on a first layout generating, using a first error data extracting module, first error data based on the first layout and the test pattern, wherein the first error data is a value of misalignment of the test pattern from a reference position, normalizing, using a first coordinate data extracting module, the coordinate information of the first layout to a target dimension to obtain first coordinate data, generating, using a first stress distribution data extracting module, first stress distribution data by performing finite element simulation analysis, wherein a boundary condition of the first stress distribution data extracting module is determined based on the first coordinate data, generating, using an error prediction machine learning model generating module, an error prediction machine learning model based on the first error data, the first coordinate data, and the first stress distribution data, generating, using a second coordinate data extracting module, second coordinate data based on coordinate information of a second layout and normalizing the coordinate information of the second layout to the target dimension, wherein the second layout is different from the first layout, generating, using a second stress distribution data extracting module, second stress distribution data by performing finite element simulation analysis, wherein a boundary condition of the second stress distribution data extracting module is determined based on the second coordinate data; and predicting, using a second error data predicting module, second error data of the second layout based on the second coordinate data and the second stress distribution data.

A method for manufacturing an integrated circuit device, including disposing a mold structure on a substrate, penetrating the mold structure to obtain a plurality of holes, forming a plurality of lower electrodes filling the plurality of holes, forming a plurality of opening patterns penetrating the mold structure in a third direction perpendicular to the substrate based on a final layout of a layout design, forming a dielectric layer covering the plurality of opening patterns, and forming an upper electrode filling the plurality of opening patterns on the dielectric layer. The layout design includes constructing an error prediction machine learning model by performing a finite element analysis simulation on a first layout, and generating, using the error prediction machine learning model, the final layout based on a second layout, wherein the second layout is different from the first layout.

### BRIEF DESCRIPTION OF THE DRAWINGS

FIG. 1 is an example flowchart of a method for layout designing according to an embodiment of the present inventive concept.

FIG. 2 is an example flowchart of a method for constructing an error prediction model according to an embodiment of the present inventive concept.

FIG. 3 is an example flowchart of a method for extracting first error data according to an embodiment of the present inventive concept.

FIG. 4 is an example diagram of first error data according to an embodiment of the present inventive concept.

FIG. 5 is an example diagram of a method for performing a finite element analysis simulation on a structural analysis mesh model according to an embodiment of the present inventive concept.

FIG. 6 is an example flowchart of a method for layout designing according to an embodiment of the present inventive concept.

FIG. 7 is an example diagram of second error data according to an embodiment of the present inventive concept.

FIG. 8 is an example diagram of a layout designing system for performing the method for layout designing according to an embodiment of the present inventive concept.

FIG. 9 is an example schematic plan view of an area of an integrated circuit device according to an embodiment of the present inventive concept.

FIG. 10 is an example schematic cross-sectional view taken along line X1-X1′ of FIG. 7.

FIG. 11 is an example flowchart of a method for manufacturing an integrated circuit device according to an embodiment of the present inventive concept.

FIGS. 12A, 12B, 12C, 12D, 12E, and 12F are example cross-sectional views of an integrated circuit device using the method for manufacturing the integrated circuit device according to an embodiment of the present inventive concept.

### DETAILED DESCRIPTION OF THE EMBODIMENTS

Hereinafter, embodiments of the present inventive concept are described in detail with reference to the accompanying drawings. In some cases, the same or similar reference numerals are used for the same element or similar elements. In some cases, redundant descriptions thereof may be omitted.

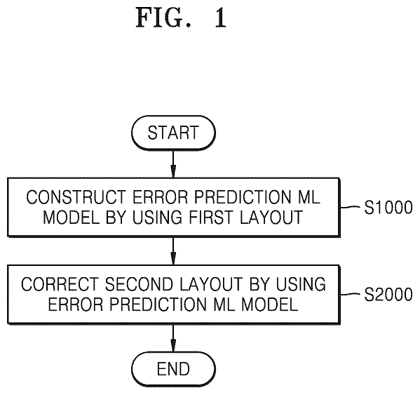

FIG. 1 is an example flowchart of a method for layout designing according to an embodiment of the present inventive concept. In some examples, these operations are performed by a system including a processor executing a set of codes to control functional elements of an apparatus. Additionally or alternatively, certain processes are performed using special-purpose hardware. In some cases, these operations are performed according to the methods and processes described in accordance with aspects of the present disclosure. In some cases, the operations described herein are composed of various substeps, or are performed in conjunction with other operations.

Referring to FIG. 1, circuit patterns of an integrated circuit device may be formed through a process of transferring a pattern on a mask to a substrate, such as a semiconductor wafer, using an exposure process. Thus, a layout for mask patterns corresponding to the circuit patterns of the integrated circuit device may be designed.

According to an embodiment, a method for layout designing may include an operation S1000 for constructing an error prediction machine learning (ML) model by using a first layout and an operation S2000 for correcting a second layout by using the error prediction ML model. In some cases, the first layout and the second layout may be different. The first layout and the second layout may be full-chip layouts. The first layout and the second layout may have different structures. The first layout may be a layout of a parent product, and the second layout may be a layout of a child product.

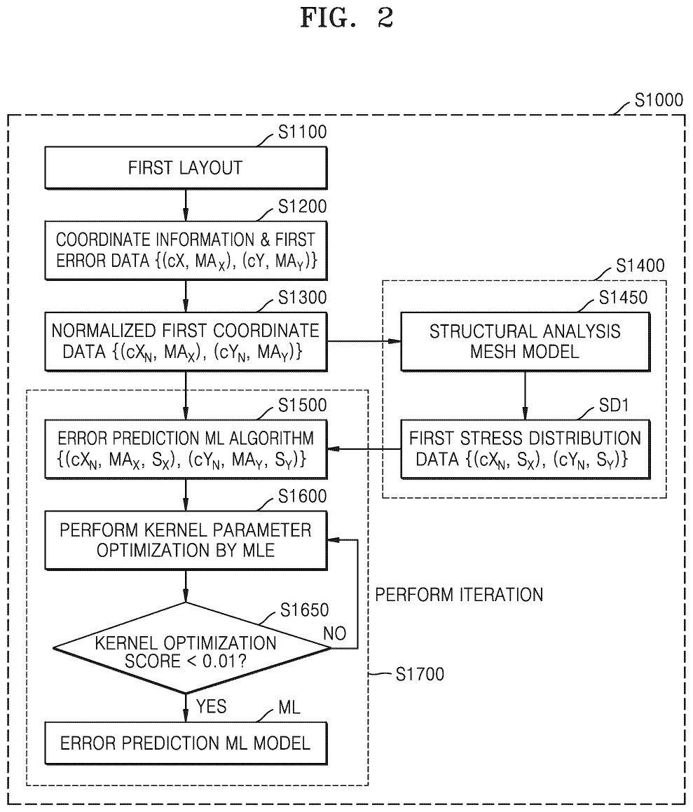

FIG. 2 is an example flowchart of a method for constructing an error prediction model according to an embodiment of the present inventive concept. For example, FIG. 2 illustrates the operation S1000 for constructing the error prediction ML model using the first layout. In some examples, these operations are performed by a system including a processor executing a set of codes to control functional elements of an apparatus. Additionally or alternatively, certain processes are performed using special-purpose hardware. In some cases, these operations are performed according to the methods and processes described in accordance with aspects of the present disclosure. In some cases, the operations described herein are composed of various substeps, or are performed in conjunction with other operations.

Referring to FIG. 2, at operation S1100, the system prepares the first layout. In an embodiment, the first layout may include a full-chip layout. For example, the full-chip layout may include the arrangement of one or more components within a semiconductor chip or an integrated circuit device. At operation S1200, the system extracts coordinate information and first error data. For example, the coordinate data and first error data may include {(cX, MAₓ), (cY, MA_{Y})}. At operation S1300, the system obtains normalized first coordinate data from the coordinate information. For example, the normalized first coordinate data may be extracted by normalizing coordinate information of the first layout. For example, the normalized first coordinate data may be {(cX_{N}, MAₓ), (cY_{N}, MA_{Y})}.

At operation S1400, the system extracts first stress distribution data. For example, at operation 1450, the system constructs a structural analysis mesh model. In some cases, the structural analysis mesh model is a computational representation of a physical structure. The structural analysis mesh model may include mesh elements connecting nodes that represent a point of the structure. In some cases, boundary conditions, material properties, loads, and analysis are applied to simulate the behavior of the structure and assess the performance of the structure. According to some embodiments, the system obtains the first stress distribution data SD1 from the structural analysis mesh model. For example, the first stress distribution data SD1 may include {(cX_{N}, Sₓ), (cY_{N}, S_{Y})}.

At operation S1700, the system generates the error prediction ML model. For example, at operation S1500, the system constructs an error prediction ML algorithm. For example, error prediction ML algorithm may be generated based on the normalized first coordinate data and the first stress distribution data. For example, the error prediction ML algorithm may include {(cX_{N}, MAₓ, Sₓ), (cY_{N}, MA_{Y}, S_{Y})}.

At operation S1600, the system performs kernel parameter optimization by maximum likelihood estimation (MLE). Then, at operation 1650, the system determines whether a kernel optimization score is less than a threshold value. For example, the threshold value may be 0.01. In some cases, when the kernel optimization score is greater than the threshold value, the system performs another kernel parameter optimization. In some cases, when the kernel optimization score is less than the threshold value, the system generates an error prediction ML model.

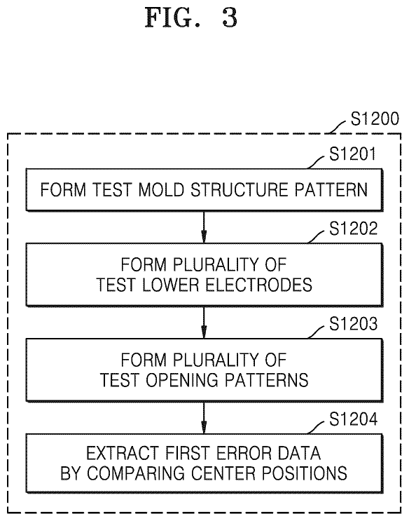

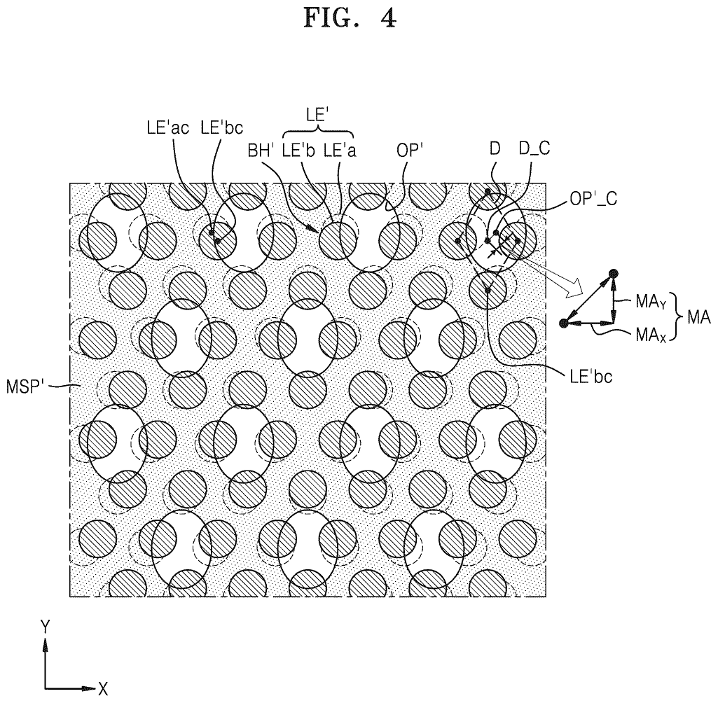

FIG. 3 is an example flowchart of a method for extracting first error data according to an embodiment of the present inventive concept. FIG. 4 is an example diagram of first error data according to an embodiment of the present inventive concept. For example, FIG. 4 illustrates a planar shape of the test pattern. However, the test pattern is not necessarily limited to the example illustrated in FIG. 4, and may be variously modified and changed within the scope of the inventive concept.

According to some embodiments, the first error data of the first layout may be obtained by forming the test pattern using the first layout. In some cases, the first error data is obtained by measuring a value that represents a misalignment between the formed test pattern and a reference position.

Referring to FIGS. 3 and 4, at operation S1200, the system extracts coordinate information and first error data. For example, operation S1201, the systems forms a test mold structure pattern MSP′. At operation S1202, the system forms a plurality of test lower electrodes LE′. At operation S1203, the system forms a plurality of test opening patterns OP′. At operation S1204, the system extracts first error data MA by comparing center positions.

Referring to FIG. 4, a plurality of test holes BH′ may be formed in the test mold structure pattern MSP′. In an embodiment, the test mold structure pattern MSP′ may be obtained by forming a test mold structure and forming a plurality of test holes BH′ penetrating the test mold structure. The plurality of test lower electrodes LE′ may be formed to fill the plurality of test holes BH′. The plurality of test opening patterns OP′ may be formed to penetrate a portion of the test mold structure pattern MSP′ to expose at least a portion of the side surface of the plurality of test lower electrodes LE′.

In an embodiment, the plurality of test lower electrodes LE′ may form a honeycomb structure arranged at the vertexes and center points of a plurality of hexagons in the plan view. Each of the six vertexes of each of the hexagons of the honeycomb structure may be a center point of each of other six hexagons arranged adjacent thereto, and a center point of the hexagon may be a shared vertex of the six hexagons.

In FIG. 4, for example, the plurality of test opening patterns OP′ are represented in an elliptical shape. In some cases, the plurality of test opening patterns OP′ are formed by removing a region (e.g., the elliptical region) of the test mold structure pattern MSP′. Centers OP′ C of the plurality of test opening patterns OP′ may be the center of the elliptical shape. In some cases, an area overlapping the test lower electrode LE′ in the elliptical area may be an area where the test mold structure pattern MSP′ is removed when forming the plurality of test holes BH′. In some cases, the plurality of test opening patterns OP′ may be a shape in which at least a portion of both ends of the major axis and both ends of the minor axis in the elliptical shape is recessed toward the center of the elliptical shape. In some cases, FIG. 4 is an example diagram of a method for obtaining the first error data by forming the test pattern. In some cases, the test pattern (e.g., a test opening pattern) is not necessarily limited to the example illustrated in FIG. 4 and may be variously modified and changed.

In an embodiment, the plurality of test lower electrodes LE′ may have a high aspect ratio, and accordingly, the plurality of test lower electrodes LE′ may collapse. As illustrated in FIG. 4, an upper surface LE′b and a lower surface LE′a of each of the plurality of test lower electrodes LE′ might not coincide with each other in the plan view. In the plan view, a center LE′bc of the upper surface LE′b and a center LE′ac of the lower surface LE′a might not coincide with each other. For example, the upper surface LE′b and a lower surface LE′a of a test lower electrode LE′ may be offset from each other in the vertical direction. For example, the vertical direction is perpendicular to an upper surface of the test mold structure pattern MSP′. In some cases, the plurality of test lower electrode LE′ may vertically penetrate the test mold structure in an angle. Accordingly, the test pattern may be misaligned from the reference position.

In an embodiment, the centers LE′bc of “n” upper surfaces LE′b (“n” is a natural number greater than or equal to 3) among the upper surfaces LE′b of the plurality of test lower electrodes LE′ may form a virtual polygon. In some cases, each of the plurality of test opening patterns OP′ may correspond to the virtual polygon. In some cases, each of the plurality of test opening patterns OP′ and a corresponding virtual polygon may be formed having centers misaligned with each other.

In some cases, the reference position relationship for extracting the first error data MA may be a position relationship in which a center OP′_C of each of the plurality of test opening patterns OP′ coincides with the center of the virtual polygon corresponding thereto in the plan view. For example, the first error data MA is a value of misalignment of the test pattern calculated from the reference position. For example, the first error data MA may be a value of misalignment calculated between the center OP′_C of each of the plurality of test opening patterns OP′ and the center of the virtual polygon. For example, the first error data MA may be the position difference between the center OP′_C of each of the plurality of test opening patterns OP′ and the center of the virtual polygon.

In FIG. 4, the centers LE′bc of four upper surfaces LE′b among the upper surfaces LE′b of the plurality of test lower electrodes LE′ may form a virtual tetragon (or a diamond shape D). For example, each of the plurality of test opening patterns OP′ may correspond to the virtual diamond shape D. In some cases, the center of each of the test opening patterns OP′ and a center of the corresponding virtual diamond shape D may be misaligned with each other.

Referring to FIG. 4, the reference position relationship for extracting the first error data MA may be a position relationship in which the center OP′_C of each of the plurality of test opening patterns OP′ coincides with a center D_C of the virtual diamond shape D corresponding thereto in the plan view. Accordingly, in an embodiment illustrated in FIG. 4, the first error data MA may be the position difference between the center OP′_C of each test opening pattern OP′ and the center D_C of the diamond shape D adjacent thereto in the plan view.

The first error data MA may include a first error value MA_{X} of misalignment of the test pattern calculated from the reference position in a first direction (e.g., X direction). The first error data MA may include a second error value MA_{Y} of misalignment of the test pattern calculated from the reference position in a second direction (e.g., Y direction). The first error data MA may be represented as a data pair {(cX, MA_{X}), (cY, MA_{Y})} based on the coordinate information of the first layout.

Referring to FIG. 2, the method for layout designing according to an embodiment may include operation S1300. At operation S1300, the system extracts the first coordinate data and normalizes the coordinate information of the first layout to obtain a normalized first coordinate data. At operation S1400, the system generates the first stress distribution data.

Coordinate information (cX, cY) of the first layout may be normalized to first coordinate data (cX_{N}, cY_{N}) to a target dimension or pre-determined dimension. In an embodiment, the coordinate information of the first layout may be normalized such that each of the X-direction coordinate and the Y-direction coordinate has a maximum dimension of 1. By normalizing and using the coordinate information of the first layout, the configuration information of the corresponding structure may be determined regardless of the dimension of the layout. In an embodiment, the normalized first error data may be represented as a data pair {(cX_{N}, MA_{X}), (cY_{N}, MA_{Y})}. In one aspect, the normalized first error data includes the normalized first coordinate data and the first error data.

At operation S1450, the system may construct a structural analysis mesh model based on the normalized first coordinate data (cX_{N}, cY_{N}). For example, the first stress distribution data SD1 may be obtained by setting a boundary condition in the constructed mesh model and performing a finite element analysis simulation.

In some cases, the structural analysis mesh model is a computational representation of a physical structure. The structural analysis mesh model may include mesh elements connecting nodes that represent a point of the structure. In some cases, boundary conditions, material properties, loads, and analysis are applied to simulate the behavior of the structure and assess the performance of the structure. According to some embodiments, the system obtains the first stress distribution data SD1 from the structural analysis mesh model. For example, the first stress distribution data SD1 may include {(cX_{N}, Sₓ), (cY_{N}, S_{Y})}.

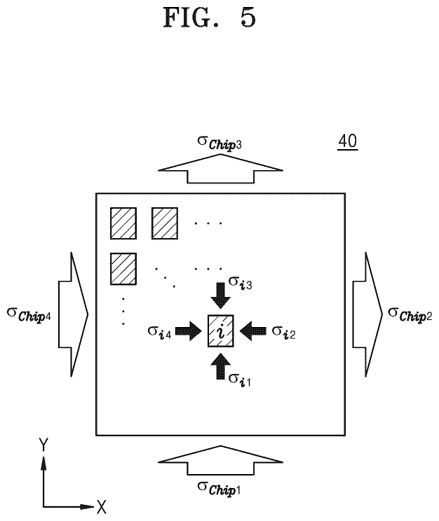

FIG. 5 is an example diagram of a method for performing a finite element analysis simulation on a structural analysis mesh model according to an embodiment of the present inventive concept. Finite element analysis (FEA) simulation is a computational tool used to simulate and analyze how a structure respond to physical effects such as forces, heat, and vibrations by dividing the structure into smaller elements.

Referring to FIG. 5, a boundary condition (σ_{Chip1}, σ_{Chip2}, σ_{Chip3}, σ_{Chip4}) for applying a force to the edge of a structural analysis mesh model 40 may be set. Accordingly, the first stress distribution data may be extracted by calculating a stress (σᵢ₁, σᵢ₂, σᵢ₃, σᵢ₄) acting on each coordinate (i). In some cases, the direction of the boundary condition (σ_{Chip1}, σ_{Chip2}, σ_{Chip3}, σ_{Chip4}) and the direction of the stress (σᵢ₁, σᵢ₂, σᵢ₃, σᵢ₄) acting on each coordinate (i) illustrated in FIG. 5 are arbitrarily represented. In some cases, the boundary condition may be adjusted as necessary and the direction of the stress (σᵢ₁, σᵢ₂, σᵢ₃, σᵢ₄) acting on each coordinate (i) may be changed accordingly. For example, the force applied in FIG. 5 may be a compressive force, where a force is applied toward a center of the structure. In some cases, for example, the for applied may be a tensile force, where a force is applied away from a center of the structure. In some cases, the force applied may be shear force, bending force, torsional force, normal force, frictional force, buoyant force, centrifugal force, or centripetal force.

The first stress distribution data may include a first stress value measured Sx in the first direction (e.g., X direction) and a second stress value Sy measured in the second direction (e.g., Y direction) at each coordinate (i). The first stress distribution data may be represented as a data pair {(cX_{N}, S_{X}), (cY_{N}, S_{Y})} based on the coordinate information of the first layout. For example, the first stress distribution data may include the normalized first coordinate data. According to some embodiments, since an overall stress distribution of the layout is calculated and used to construct an error prediction ML model, the layout may be designed based on the structural characteristics and the physical characteristics of the layout.

Referring to FIG. 2, operation S1700 may include one or more sub-operations. For example, at operation S1500, the system constructs an error prediction ML algorithm by using the first coordinate data, the first error data, and the first stress distribution data as input data. The error prediction ML algorithm may be a Gaussian process regression (GPR) algorithm based on a multi-kernel function. In an embodiment, the multi-kernel function may include one or more of RBF, White, and Matern52. In some cases, since a multi-kernel function-based algorithm is used, the error prediction ML model may predict an error in the layout of various structures.

In some cases, at operation S1600, the system performs a multi-kernel parameter optimization. For example, the system may apply a maximum likelihood estimation (MLE) to perform the multi-kernel parameter optimization. In some cases, for example, at operation S1650, the system determines whether a kernel optimization score is less than a threshold value. The multi-kernel parameter optimization may include performing one or more iterations of kernel parameter optimization based on an optimization score. For example, when the kernel optimization score is greater than the threshold value, the system performs a second kernel parameter optimization. In an embodiment, the optimization score may be 0.01. By automatically optimizing kernel parameters using the MLE, the system can generate a high-accuracy error prediction ML model and prevent an overcorrection that may occur when using a multi-kernel function.

According to some embodiments, the present inventive concept includes a method for layout designing using the error prediction ML model constructed through the operations described above with reference to FIGS. 1 to 5. In some aspects, the error prediction ML model may predict error data according to the input of coordinate information and stress distribution data of the layout requiring error prediction in an overall area of the chip.

For example, an ML model may be constructed based on an initial layout of a parent product, and a final layout may be designed by correcting the layout of child products using the ML model. For example, since an error occurring in the layout of pre-correction child products may be predicted using the error prediction ML model, the production of a mask for measuring an error occurring in the layout of child products may be omitted. Accordingly, the process cost may be reduced and the final layout may be efficiently designed.

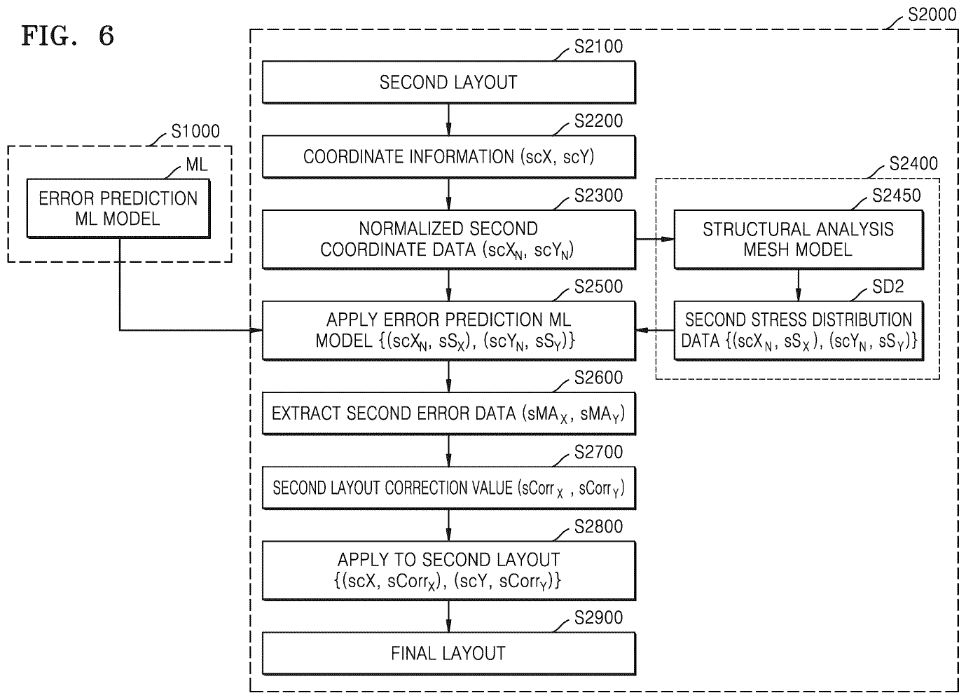

FIG. 6 is an example flowchart schematically of a method for layout designing according to an embodiment of the present inventive concept. In one aspect, FIG. 6 includes one or more sub-operations of the operation S2000 in FIG. 1. In some examples, these operations are performed by a system including a processor executing a set of codes to control functional elements of an apparatus. Additionally or alternatively, certain processes are performed using special-purpose hardware. In some cases, these operations are performed according to the methods and processes described in accordance with aspects of the present disclosure. In some cases, the operations described herein are composed of various substeps, or are performed in conjunction with other operations

Referring to FIG. 6, the operation S2000 may include one or more sub-operations. For example, at operation S2100, the system prepares a second layout. In some cases, the second layout may be a different layout than the first layout. At operation S2200, the system obtains coordinate information of the second layout. For example, the coordinate information of the second layout may be represented as (scX, scY). At operation S2300, the system generates normalized second coordinate data by normalizing the coordinate information of the second layout. For example, the normalized second coordinate data may be represented as (scX_{N}, scY_{N}).

In some embodiments, at operation S2400, the system generates second stress distribution data based on the normalized second coordinate data. For example, at operation S2450, the system constructs a structural analysis mesh model. In some cases, the systems sets parameters of the structural analysis mesh model. In some cases, the second stress distribution data may be represented as {(scX_{N}, sSₓ), (scY_{N}, sS_{Y})}.

In some embodiments, at operation S2500, the system applies an error prediction ML model to the second layout. At operation S2600, the system extracts second error data. For example, the second error data may be represented as (sMA_{X}, sMA_{Y}). At operation S2700, the system calculates a second layout correction value. For example, the second layout correction value may be represented as (sCorr_{X}, sCorr_{Y}). At operation S2800, the system applies the second layout correction value to the second layout. For example, the result can be represented as {(sc_{X}, sCorr_{X}), (scY, sCorr_{Y})}. At operation S2900, the system designs a final layout based on the result.

In some cases, the second layout may have a different structure than the first layout used to construct the error prediction ML model. The first layout may be the layout of a parent product, and the second layout may be the layout of a child product. First, a second layout may be prepared and coordinate information of the second layout may be obtained (at operation S2100 and operation S2200).

Coordinate information (scX, scY) of the second layout may be normalized to second coordinate data, or normalized second coordinate data (scX_{N}, scY_{N}) to have a target dimension. In an embodiment, the second coordinate data of the second layout may be normalized to the same dimension as the first coordinate data of the first layout. In an embodiment, the coordinate information of the second layout may be normalized such that each of the X-direction coordinate and the Y-direction coordinate has a maximum dimension of 1. By normalizing and using the coordinate information of the second layout, the configuration information of the corresponding structure may be determined regardless of the dimension of the layout.

At operation S2400, the system generates the second stress distribution data SD2 using a structural analysis mesh model constructed based on the second coordinate data (scX_{N}, scY_{N}). Second stress distribution data SD2 may be extracted by setting a boundary condition in the constructed mesh model and performing a finite element analysis simulation. the structural analysis mesh model may be an example of, or includes aspects of, the corresponding element described with reference to FIG. 2.

A method of extracting the second stress distribution data of the second layout may be performed like (or similarly to) a method of extracting the first stress distribution data of the first layout described above with reference to FIG. 5. A boundary condition for applying a force to the edge of a structural analysis mesh model may be set, and accordingly, a stress acting on each coordinate may be calculated to extract second stress distribution data. The second stress distribution data may include a first stress value sS_{X} measured in the first direction (e.g., X direction) and a second stress value sS_{Y} measured in the second direction (e.g., Y direction) at each coordinate. The second stress distribution data may be represented as a data pair {(scX_{N}, sS_{X}), (scY_{N}, sS_{Y})} based on the coordinate information of the second layout. For example, the second stress distribution data may be generated based on the normalized second coordinate data. According to some embodiments, since an overall stress distribution of the layout is calculated and applied to an error prediction ML model by substitution, the layout may be designed based on the structural characteristics and the physical characteristics of the layout.

Second error data may be extracted by inputting the normalized second coordinate data and the second stress distribution data of the second layout into the error prediction ML model (at operation S2500 and operation S2600). For example, at operation S2500, the normalized second coordinate data and the second stress distribution data of the second layout may be input into the error prediction ML model described with reference to FIG. 2.

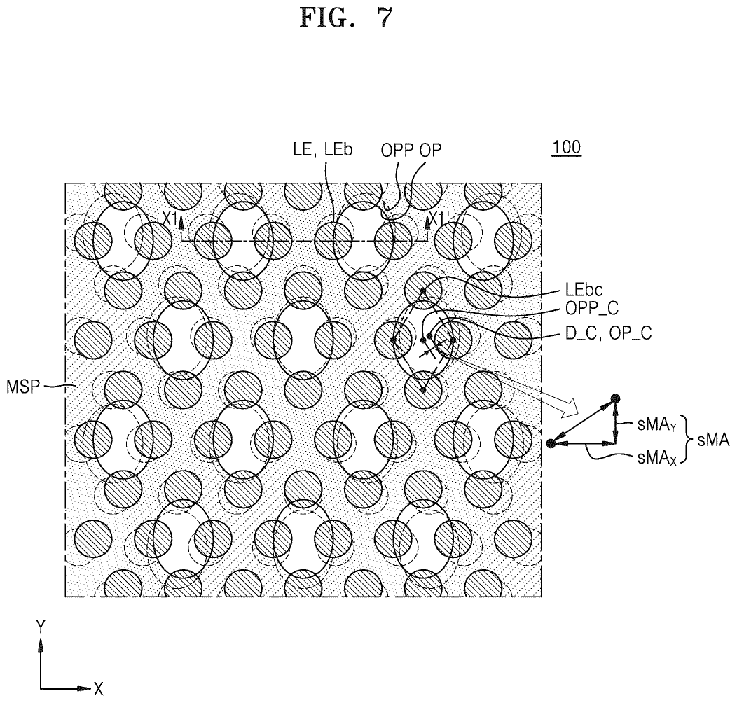

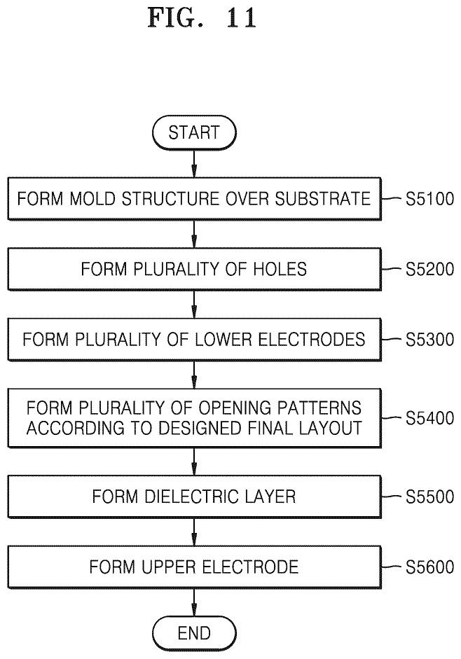

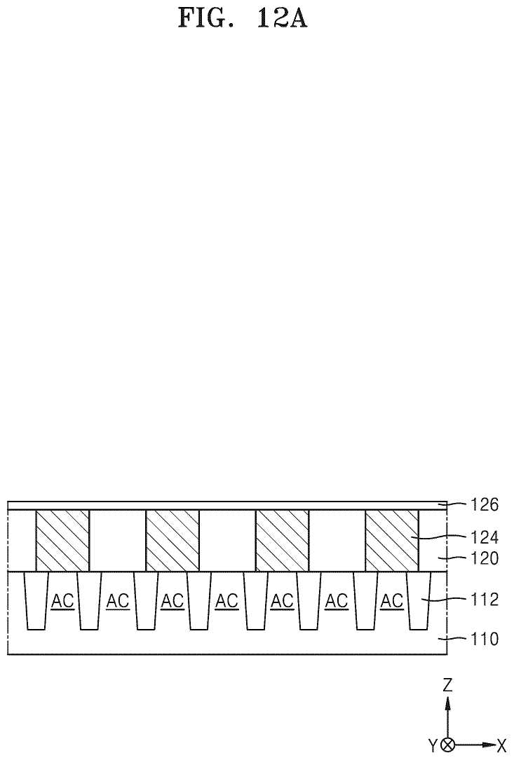

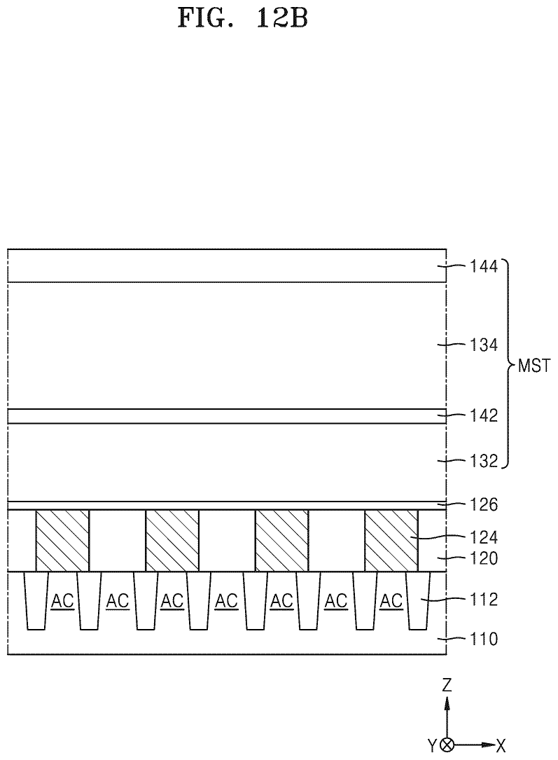

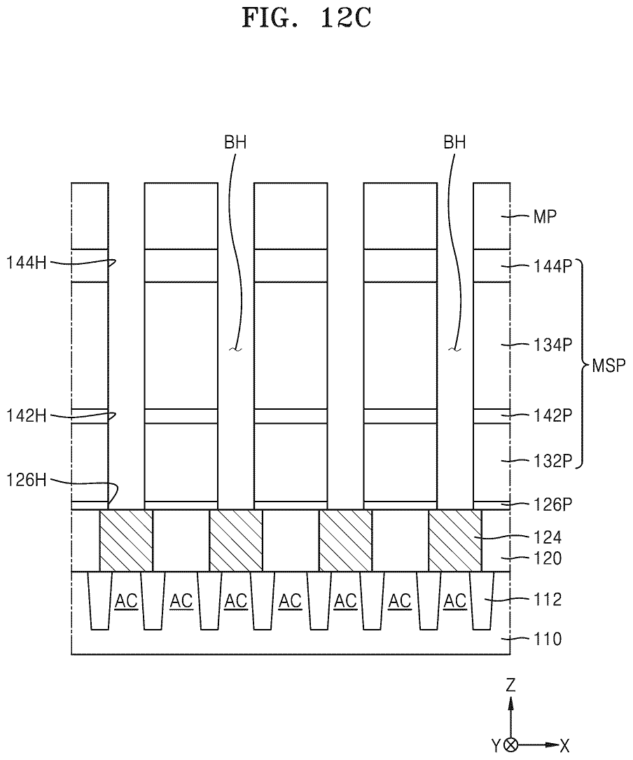

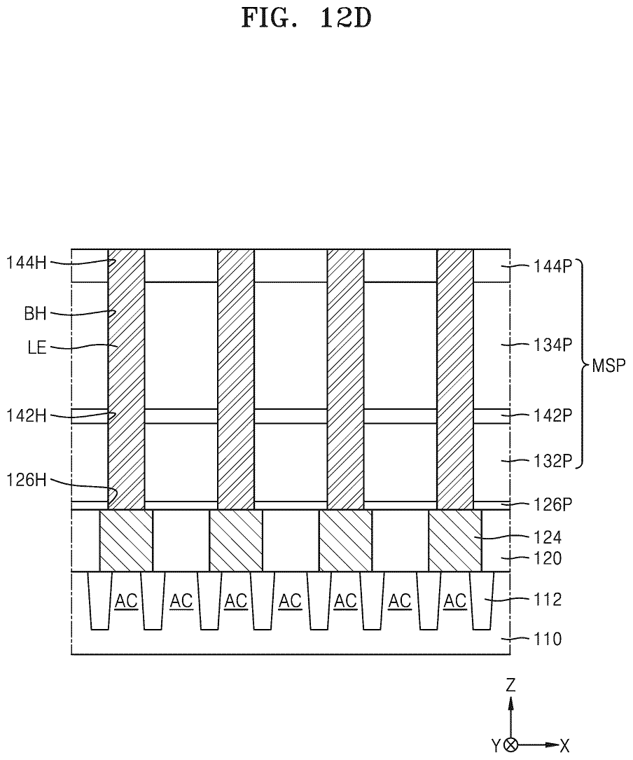

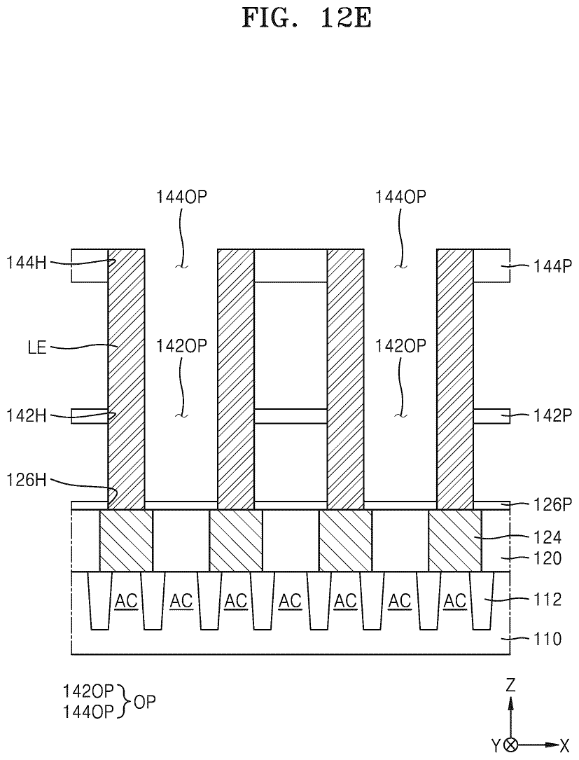

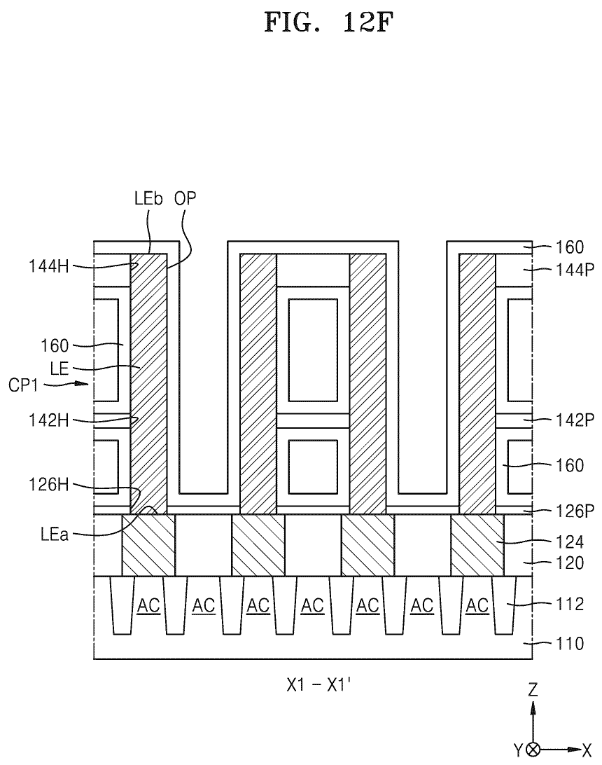

FIG. 7 is an example diagram of second error data according to an embodiment of the present inventive concept. In some cases, FIG. 7 is a plan view of an area of an integrated circuit device formed using a final layout designed using the method described according to the present inventive concept. In FIG. 7, a plurality of opening patterns OPP corresponding to a pre-correction second layout are indicated by dotted lines, and a plurality of opening patterns OP corresponding to a post-correction second layout (or a final layout) are indicated by solid lines. A detailed description about FIG. 7 is described reference to FIGS. 11 to 12F.

Referring to FIG. 7, an integrated circuit device 100 may include a plurality of lower electrodes LE, and for simplicity of illustration, the plurality of lower electrodes LE are illustrated based on an upper surface LEb among the upper surface LEb and a lower surface of the plurality of lower electrodes LE. In some cases, the lower surface of the plurality of lower electrodes LE may be represented as the dashed circled adjacent to the upper surface Leb of the plurality of lower electrodes LE.

In an embodiment, the plurality of lower electrodes LE may have a high aspect ratio, and accordingly, the plurality of lower electrodes LE may collapse. Accordingly, when forming a plurality of opening patterns OPP corresponding to a pre-correction second layout, a center OPP_C of the plurality of pre-correction opening patterns OPP may not be formed at a target position.

In an embodiment, centers LEbc of “n” upper surfaces LEb (“n” is a natural number greater than or equal to 3) among the upper surfaces LEb of the plurality of lower electrodes LE may form a virtual polygon. For example, each of pre-correction opening patterns OPP may correspond to the virtual polygon. In some cases, each of pre-correction opening patterns OPP and the virtual polygon may be formed such that the centers of each of pre-correction opening patterns OPP and the virtual polygon are misaligned. The second error data predicted through the error prediction ML model may represent the position difference between the center OPP_C of the pre-correction opening pattern OPP and the center of the virtual polygon.

For example, as an embodiment, FIG. 7 illustrates that the centers of four upper surfaces LEb among the upper surfaces LEb of the plurality of lower electrodes LE form a virtual tetragon (or a diamond shape). Each of the plurality of opening patterns OPP according to the pre-correction layout may correspond to the virtual diamond shape. A center of each of the plurality of opening patterns OPP and a center of the virtual diamond shape may be misaligned with each other. In the example of FIG. 7, the second error data sMA predicted through the error prediction ML model may represent the position difference between the center OPP_C of the pre-correction opening pattern OPP and the center D_C of the diamond shape.

Referring to FIGS. 6 and 7, the predicted second error data sMA may include a first error value sMA_{X} of misalignment measured in the first direction (e.g., X direction) and a second error value sMA_{Y} of misalignment measured in the second direction (e.g, Y direction).

At operation S2700, a second layout correction value may be calculated based on the second error data. A first correction value sCorr_{X} measured in the first direction (e.g., X direction) and a second correction value sCorr_{Y} measured in the second direction (e.g., Y direction) may be extracted through the first error value sMA_{X} and the second error value sMA_{Y} from the second error data. Then, a final layout may be designed by applying the correction values sCorr_{X} and sCorr_{Y} to the second layout (at operation S2800 and operation S2900).

FIG. 7 illustrates a plurality of opening patterns OP according to the final layout. In some cases, by extracting the second error data sMA through the error prediction ML model, correcting the second layout accordingly, and designing the final layout, the center of the plurality of opening patterns OP of the final layout may coincide with the center D_C of the diamond shape generated based on, for example, the centers of four upper surfaces LEb among the upper surfaces LEb of the plurality of lower electrodes LE. For example, the center OP_C of each of the plurality of opening patterns OP of the final layout may coincide with the center of the virtual polygon (the center D_C of the diamond shape in FIG. 7) formed by the centers LEbc of the upper surfaces LEb of “n” lower electrodes LE (“n” is a natural number greater than or equal to 3) adjacent to the center OP_C of each of the plurality of opening patterns OP among the plurality of lower electrodes LE.

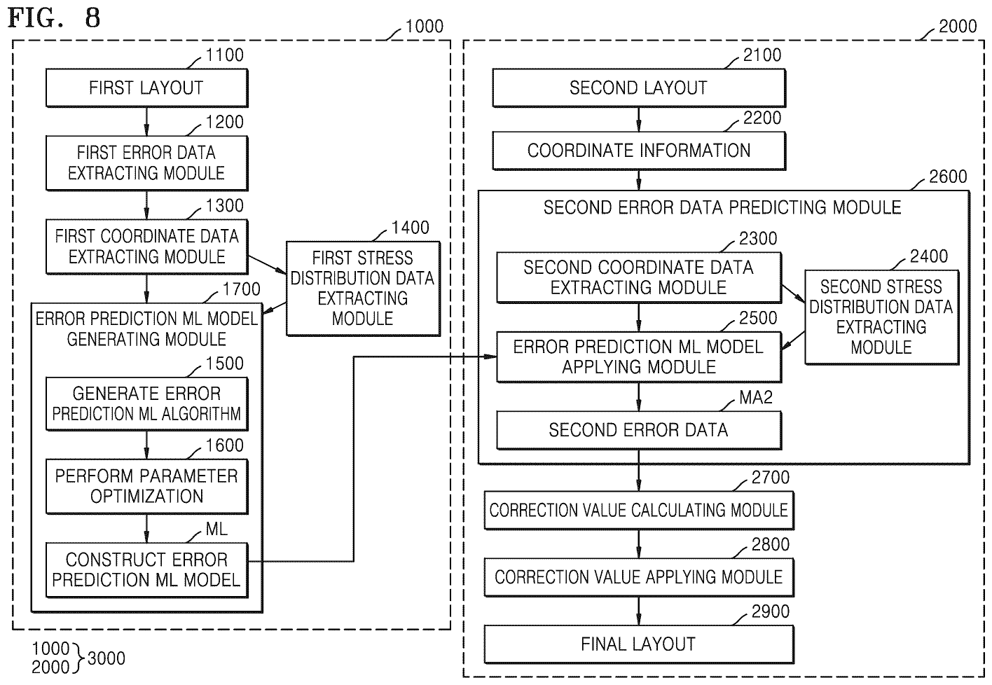

FIG. 8 is an example diagram of a layout designing system for performing the method for layout designing according to an embodiment of the present inventive concept. Referring to FIG. 8, a layout designing system 3000 may include an error prediction ML model constructing system 1000 and an error prediction ML model utilization system 2000.

The error prediction ML model constructing system 1000 may include a first error data extracting module 1200, a first coordinate data extracting module 1300, a first stress distribution data extracting module 1400, and an error prediction ML model generating module 1700. The first error data extracting module 1200 may receive data on a test pattern formed by using a first layout 1100. Then, the first error data extracting module 1200 generates first error data having a value of misalignment of the test pattern from a reference position based on the first layout 1100. A method for extracting the first error data is described with reference to FIGS. 3 and 4.

The first coordinate data extracting module 1300 may receive coordinate information based on the first layout 1100. In some cases, the first coordinate data extracting module 1300 normalizes the coordinate information to a set dimension and generates a normalized first coordinate data.

The first stress distribution data extracting module 1400 may construct a structural analysis mesh model based on the first coordinate data generated from the first coordinate data extracting module 1300. In some cases, the first stress distribution data extracting module 1400 sets a boundary condition and generates the first stress distribution data using finite element simulation analysis. A method of extracting the first stress distribution data is described with reference to FIG. 5.

The error prediction ML generating module 1700 may generate an error prediction ML algorithm 1500 based on the first error data, the first coordinate data, and the first stress distribution data. The error prediction ML generating module 1700 may perform a Gaussian process regression (GPR) algorithm based on a multi-kernel function. In some cases, the error prediction ML generating module 1700 performs multi-kernel parameter optimization 1600 by applying a maximum likelihood estimation (MLE). Accordingly, the error prediction ML model constructing system 1000 may construct an error prediction ML model (ML).

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 615 and executable by processor unit 605, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

The error prediction ML model utilization system 2000 may include a second error data predicting module 2600, a correction value calculating module 2700, and a correction value applying module 2800. The second error data predicting module 2600 may include a second coordinate data extracting module 2300, a second stress distribution data extracting module 2400, and an error prediction ML model applying module 2500.

The second coordinate data extracting module 2300 may receive coordinate information 2200 of a second layout 2100 and normalize the coordinate information 2200 to a set dimension to generate second coordinate data. For example, the second layout 2100 may be different from the first layout 1100.

The second stress distribution data extracting module 2400 may construct a structural analysis mesh model based on the second coordinate data generated from the second coordinate data extracting module 2300. In some cases, the second stress distribution data extracting module 2400 may set a boundary condition and extract second stress distribution data using finite element simulation analysis.

The second error data predicting module 2600 may predict second error data MA2 based on the second coordinate data and the second stress distribution data. For example, the second coordinate data and the second stress distribution data are input into the error prediction ML model 2500 of the second error data predicting module 2600. The correction value calculating module 2700 may calculate a correction value based on the second error data MA2. The correction value applying module 2800 may generate a final layout 2900 based on the correction value calculated by the correction value calculating module 2700 and the second layout 2100.

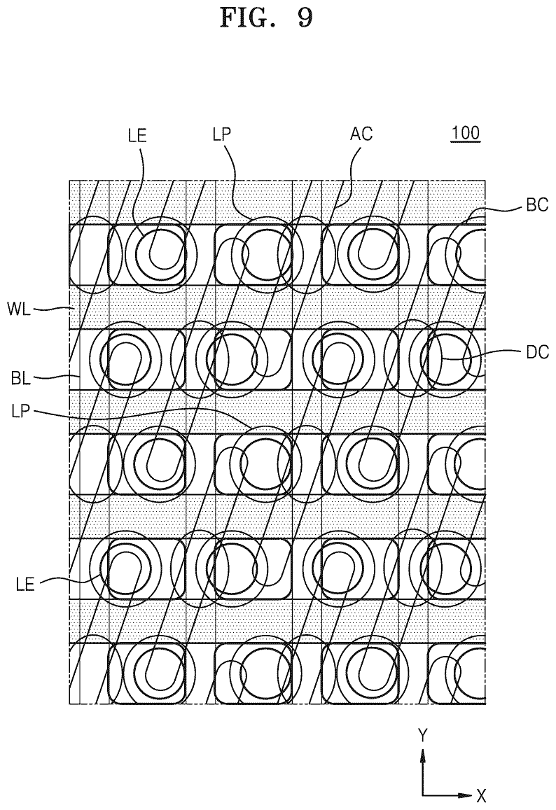

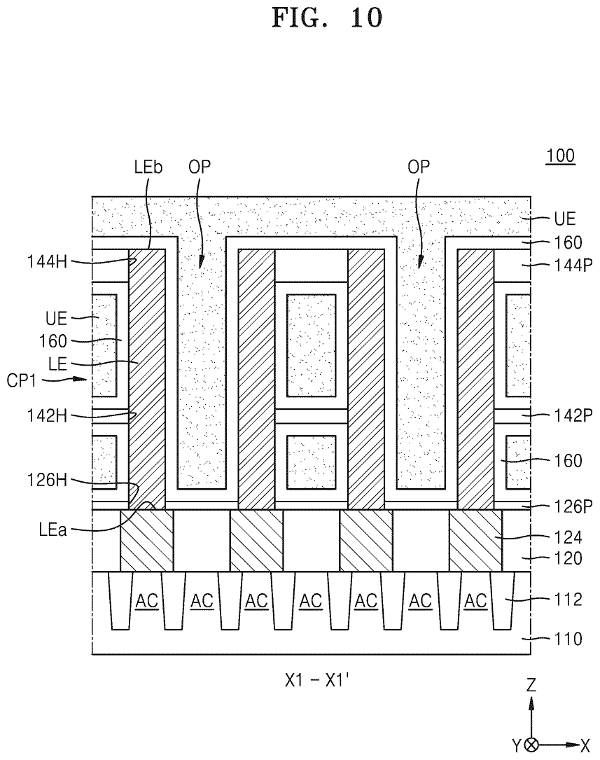

FIG. 9 is an example schematic plan view of a portion of a memory cell array area of an integrated circuit device according to an embodiment of the present inventive concept. FIG. 10 is an example schematic cross-sectional view taken along line X1-X1′ of FIG. 7.

Referring to FIG. 9, an integrated circuit device 100 may include a plurality of active arcas AC arranged to extend horizontally in a diagonal direction with respect to the first direction (X direction) and the second direction (Y direction). For example, the first direction and the second direction are perpendicular to each other in the plan view. A plurality of word lines WL may extend parallel to each other in the first direction (X direction) across the plurality of active areas AC. A plurality of bit lines BL may extend parallel to each other in the second direction (Y direction) and perpendicularly crossing the plurality of word lines WL. Each of the plurality of bit lines BL may be connected to the active area AC through a direct contact DC.

A plurality of buried contacts BC may be formed between two adjacent bit lines BL among the plurality of bit lines BL. A plurality of conductive landing pads LP may be formed over the plurality of buried contacts BC. Each of the plurality of conductive landing pads LP may be arranged to at least partially overlap the buried contact BC. A plurality of lower electrodes LE spaced apart from each other may be formed over the plurality of conductive landing pads LP. The plurality of lower electrodes LE may be connected to the plurality of active areas AC through the plurality of buried contacts BC and the plurality of conductive landing pads LP.

Referring to FIG. 10, an integrated circuit device 100 may include a substrate 110 comprising a plurality of active areas AC. The integrated circuit device 100 may include a lower structure 120 disposed on the substrate 110. A plurality of conductive areas 124 may penetrate the lower structure 120 in the vertical direction (e.g., Z direction) to be connected to the plurality of active areas AC. In some cases, upper surfaces of the conductive areas 124 may be substantially coplanar with upper surfaces of the lower structure 120.

The substrate 110 may include semiconductor elements such as Si and/or Ge. In some cases, the substrate 110 may include compound semiconductors such as SiC, GaAs, InAs, and/or InP. substrate 110 may include a semiconductor substrate, one or more insulating layers disposed on the semiconductor substrate, or structures including one or more conductive areas. The conductive area may include, for example, a well doped with dopants or a structure doped with dopants. A device isolation layer 112 may separate the substrate 110 into the plurality of active areas AC formed in the substrate 110. The device isolation layer 112 may include an oxide layer, a nitride layer, or a combination thereof.

In some embodiments, the lower structure 120 may include an insulating layer including a silicon oxide layer, a silicon nitride layer, or a combination thereof. In some embodiments, the lower structure 120 may include conductive areas such as a line layer, contact plugs, and/or transistors, and insulating layers for insulating the conductive areas from each other. The plurality of conductive areas 124 may include polysilicon, metal, conductive metal nitride, metal silicide, or any combination thereof. The lower structure 120 may include the plurality of bit lines BL described with reference to FIG. 9. Each of the plurality of conductive areas 124 may include the buried contact BC and the conductive landing pad LP described with reference to FIG. 9.

An insulating pattern 126P including a plurality of openings 126H overlapping the plurality of conductive areas 124 in the vertical direction (Z direction) may be disposed on the lower structure 120 and the plurality of conductive areas 124. The insulating pattern 126P may include silicon nitride (SiN), silicon carbonitride (SiCN), silicon boron nitride (SiBN), or any combination thereof. The terms “SiN”, “SiCN”, and “SiBN” used herein may refer to materials including elements included in the respective terms but might not refer to chemical formulas representing stoichiometric relationships.

A plurality of capacitors CPI may be disposed on the plurality of conductive areas 124. Each of the plurality of capacitors CPI may include a lower electrode LE, a dielectric layer 160 stacked over the lower electrode LE, and an upper electrode UE covering the dielectric layer 160. For example, the dielectric layer 160 may be disposed between the lower electrode LE and the upper electrode UE.

The insulating pattern 126P may be arranged adjacent to a lower end of each of the plurality of lower electrodes LE. For example, the side surfaces of the insulating pattern 126P may be in contact with a portion of side surface of the lower electrodes LE at a lower lever (e.g., a region adjacent to the lower structure 120 or the conductive areas 124). Each of the plurality of lower electrodes LE may have a pillar shape extending along from the upper surface of the conductive area 124 through the opening 126H of the insulating pattern 126P in a direction away from the substrate 110 in the vertical direction (Z direction). In FIG. 10, each of the plurality of lower electrodes LE has a pillar shape. However, the inventive concept is not necessarily limited thereto. For example, each of the plurality of lower electrodes LE may have a cross-sectional structure of a cup shape or a cylinder shape with a closed bottom portion. In some cases, each of the lower surface LEa of the lower electrodes LE may be respectively disposed on and contact an upper surface of the conductive arca 124.

The integrated circuit device 100 may further include a lower insulating support pattern 142P and an upper insulating support pattern 144P that support the plurality of lower electrodes LE. The upper insulating support pattern 144P may extend in the horizontal direction parallel to the substrate 110 and surrounds an upper end portion of each of the plurality of lower electrodes LE at a position away from the insulating pattern 126P in the vertical direction (Z direction). A plurality of holes 144H through which the plurality of lower electrodes LE penetrate may be formed in the upper insulating support pattern 144P. The inner sidewall of each of the plurality of holes 144H formed in the upper insulating support pattern 144P may contact the outer sidewall of the lower electrode LE. The upper surface of each of the plurality of lower electrodes LE and the upper surface of the upper insulating support pattern 144P may be substantially coplanar.

As illustrated in FIG. 10, the lower insulating support pattern 142P may extend in the horizontal direction parallel to the substrate 110. In some cases, the lower insulating support pattern 142P may be disposed between the substrate 110 and the upper insulating support pattern 144P and may contact the sidewalls of the plurality of lower electrodes LE. A plurality of holes 142H through which the plurality of lower electrodes LE penetrate may be formed in the lower insulating support pattern 142P. The plurality of lower electrodes LE extend long in the vertical direction (Z direction) through the plurality of holes 144H formed in the upper insulating support pattern 144P and the plurality of holes 142H formed in the lower insulating support pattern 142P.

A plurality of opening patterns OP may be formed in the upper insulating support pattern 144P and the lower insulating support pattern 142P. The plurality of opening patterns OP may expose the side surface of the lower electrode LE. The plurality of opening patterns OP may correspond to the plurality of opening patterns OP of FIG. 7.

Each of the lower insulating support pattern 142P and the upper insulating support pattern 144P may include silicon nitride (SiN), silicon carbonitride (SiCN), silicon boron nitride (SiBN), or any combination thereof. In some embodiments, the lower insulating support pattern 142P and the upper insulating support pattern 144P may include the same material. In some embodiments, the lower insulating support pattern 142P and the upper insulating support pattern 144P may include different materials. For example, each of the lower insulating support pattern 142P and the upper insulating support pattern 144P may include SiCN. For example, the lower insulating support pattern 142P may include SiCN, and the upper insulating support pattern 144P may include SiBN. However, the inventive concept is not necessarily limited to the materials described above as examples.

In some cases, for example, the dielectric layer 160 may include a single layer or any combinations of metal oxides such as HfO₂, ZrO₂, Al₂O₃, La₂O₃, Ta₂O₃, and TiO₂ and dielectric materials of a perovskite structure such as SrTiO₃ (STO), BaTiO₃, PZT, and PLZT.

The plurality of lower electrodes LE may include one or more metal materials, metal nitride layers, and metal silicides. For example, the plurality of lower electrodes LE may include a refractory metal material such as cobalt, titanium, nickel, tungsten, and/or molybdenum. For example, the plurality of lower electrodes LE may include metal nitride such as titanium nitride (TiN), titanium silicon nitride (TiSiN), titanium aluminum nitride (TiAlN), tantalum nitride (TaN), tantalum silicon nitride (TaSiN), tantalum aluminum nitride (TaAlN), and/or tungsten nitride (WN). In some cases, the plurality of lower electrodes LE may include one or more noble metal material of platinum (Pt), ruthenium (Ru), and iridium (Ir). The plurality of lower electrodes LE may include noble metal oxide.

The upper electrode UE may include one or more doped silicon, silicon germanium, metal materials, metal nitride layers, and metal silicides. The upper electrode UE may include the same material as the plurality of lower electrodes LE. However, the inventive concept is not necessarily limited thereto. Each of the lower electrode LE and the upper electrode UE may include a metal layer, a conductive metal oxide layer, a conductive metal nitride layer, a conductive metal oxynitride layer, or any combination thereof.

FIG. 11 is an example flowchart of a method for manufacturing an integrated circuit device according to an embodiment of the present inventive concept. FIGS. 12A to 12F are example cross-sectional views of an integrated circuit device using the method for manufacturing the integrated circuit device according to an embodiment of the present inventive concept.

Referring to FIG. 11, the method for manufacturing an integrated circuit device may be performed by a system including a processor executing a set of codes to control functional elements of an apparatus. Additionally or alternatively, certain processes are performed using special-purpose hardware. In some cases, these operations are performed according to the methods and processes described in accordance with aspects of the present disclosure. In some cases, the operations described herein are composed of various substeps, or are performed in conjunction with other operations.

At operation S5100, the system forms a mold structure MST (see FIG. 12B) over a substrate. At operation S5200, the system forms a plurality of holes BH (see FIG. 12C) penetrating the mold structure MST (see FIG. 12B). At operation S5300, the system forms a plurality of lower electrodes LE (see FIG. 10) filling the plurality of holes BH (see FIG. 12C). At operation S5400, the system forms a plurality of opening patterns OP (see FIG. 10) penetrating the mold structure according to the designed final layout. At operation S5500, the system forms a dielectric layer covering the plurality of opening patterns OP. At operation S5600, the system forms an upper electrode filling the plurality of opening patterns. The designed final layout used in the operation S5400 for forming the plurality of opening patterns OP (see FIG. 10) may generated based on the method for layout designing described with reference to FIGS. 1 to 8.

Referring to FIG. 12A, on a substrate 110 in which an active area AC is separated by a device isolation layer 112, a lower structure 120 and a conductive area 124 connected to the active area AC may be formed. In some cases, the conductive area 124 may penetrate the lower structure 120. Then, an insulating layer 126 may be formed to cover the lower structure 120 and the conductive area 124.

In some embodiments, the insulating layer 126 may be disposed on and covering the lower structure 120 and the conductive area 124. The insulating layer 126 may be used as an etch stop layer in a subsequent process. The insulating layer 126 may include an insulating material having an etch selectivity with respect to the lower structure 120. In embodiments, the insulating layer 126 may include silicon nitride (SiN), silicon carbonitride (SiCN), silicon boron nitride (SiBN), or any combination thereof.

Referring to FIG. 12B, a mold structure MST may be formed on the insulating layer 126. The mold structure MST may include a plurality of mold layers and a plurality of support layers. For example, the mold structure MST may include a first mold layer 132, a lower insulating support layer 142, a second mold layer 134, and an upper insulating support layer 144 sequentially stacked on the insulating layer 126. In some embodiments, each of the first mold layer 132 and the second mold layer 134 may include an oxide layer, a nitride layer, or a combination thereof. However, the component materials of each of the first mold layer 132 and the second mold layer 134 are not necessarily limited to the above examples and may be modified and changed within the scope of the inventive concept. In some cases, the stack order of the mold structure MST is not necessarily limited to the example illustrated in FIG. 12B and may be modified and changed within the scope of the inventive concept.

Each of the lower insulating support layer 142 and the upper insulating support layer 144 may include silicon nitride (SiN), silicon carbonitride (SiCN), silicon boron nitride (SiBN), or any combination thereof. In some embodiments, the lower insulating support layer 142 and the upper insulating support layer 144 may include a material having an etch selectivity with respect to the first mold layer 132 and the second mold layer 134. In some embodiments, the lower insulating support layer 142 and the upper insulating support layer 144 may include the same material. In some embodiments, the lower insulating support layer 142 and the upper insulating support layer 144 may include different materials. For example, each of the lower insulating support layer 142 and the upper insulating support layer 144 may include a silicon carbonitride layer. For example, the lower insulating support layer 142 may include a silicon carbonitride layer, and the upper insulating support layer 144 may include a boron-containing silicon nitride layer. However, the component materials of the lower insulating support layer 142 and the upper insulating support layer 144 are not necessarily limited to the above examples and may be modified and changed within the scope of the inventive concept.

Referring to FIG. 12C, a mask pattern MP may be formed on the mold structure MST in the resulting structure of FIG. 12B. Then, an anisotropically etching process is performed to remove materials in the mold structure MST and forming a plurality of holes BH in the mold structure MST using the mask pattern MP as an etch mask and the insulating layer 126 as an etch stop layer. Accordingly, the mold structure pattern MSP is formed.

The mold structure pattern MSP may include a first mold pattern 132P, a lower insulating support pattern 142P, a second mold pattern 134P, and an upper insulating support pattern 144P. The mask pattern MP may include a nitride layer, an oxide layer, a polysilicon layer, a photoresist layer, or any combination thereof.

Thereafter, a portion of the insulating layer 126 may be removed during the etching process to form an insulating pattern 126P. In some cases, the insulating pattern 126P includes a plurality of openings 126H exposing a portion of an upper surface of each of a plurality of conductive areas 124.

In the mold structure pattern MSP, a plurality of holes 142H that are portions of the plurality of holes BH may be formed in the lower insulating support pattern 142P. In some cases, a plurality of holes 144H that are portions of the plurality of holes BH may be formed in the upper insulating support pattern 144P.

Referring to FIG. 12D, a plurality of lower electrodes LE filling the plurality of holes BH may be formed in the resulting structure of FIG. 12C. In some embodiments, in order to form the plurality of lower electrodes LE, a conductive layer may be disposed on and covering the upper surface of the upper insulating support pattern 144P. In some cases, the conductive layer fills the plurality of holes BH. In some cases, the upper surface of the conductive layer may be planarized until the upper surface of the insulating support pattern 144P is exposed.

Referring to FIG. 12E, a plurality of opening patterns OP penetrating a portion of the mold structure pattern MSP may be formed in the resulting structure of FIG. 12D. The plurality of opening patterns OP may be formed based on the method for layout design described with reference to FIGS. 1 to 8. For example, the final layout used to form the plurality of opening patterns OP may be a layout corrected by applying an error prediction ML model to a certain layout.

A plurality of upper openings 144OP may be formed by removing a portion of the upper insulating support pattern 144P. In some cases, the second mold pattern 134P may be removed in a wet etching manner through the plurality of upper openings 144OP. Thereafter, a plurality of lower openings 142OP may be formed by removing a portion of the lower insulating support pattern 142P exposed through the plurality of upper openings 144OP. In some cases, the upper surface of the insulating pattern 126P may be exposed by removing the first mold pattern 132P in a wet etching manner through the plurality of lower openings 142OP. After the first mold pattern 132P and the second mold pattern 134P are removed, the sidewalls of the plurality of lower electrodes LE may be exposed by the plurality of opening patterns OP.

Referring to FIG. 12F, a dielectric layer 160 covering the plurality of opening patterns OP may be formed in the resulting structure of 12E with the plurality of opening patterns OP formed therein. Thereafter, an upper electrode UE filling the plurality of opening patterns OP may be formed on the dielectric layer 160 to form the integrated circuit device illustrated in FIG. 10. The inventive concept provides a method for layout designing that efficiently designs a layout by correcting a layout and an integrated circuit device manufacturing method using the layout designing method.

Although correcting a misalignment in the operation of forming the plurality of opening patterns OP has been mainly described herein, the present embodiments are not limited thereto. For example, the present embodiments may be applied to correct a misalignment in the operation of forming other components such as the lower electrode LE. Also, although examples in which the present embodiments are applied to dynamic random access memories (DRAMs) have been mainly described herein, the present embodiments may also be applied to channel structures, contacts, or the like of flash memory devices.

Although embodiments of the present disclosure have been described with reference to the accompanying drawings, the present disclosure is not necessarily limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects.

What is claimed is:

1. A method for layout designing, comprising:
preparing a first layout;
forming a test pattern based on the first layout;
generating first error data based on the first layout and the test pattern, wherein the first error data includes a value of misalignment of the test pattern from a reference position;
normalizing coordinate data of the first layout to obtain first coordinate data;
generating, using a structural analysis mesh model, first stress distribution data by performing finite element analysis simulation, wherein a boundary condition of the structural analysis mesh model is determined based on the first coordinate data;
generating an error prediction machine learning model based on the first error data, the first coordinate data, and the first stress distribution data;
predicting, using the error prediction machine learning model, second error data of a second layout, wherein the second layout is different from the first layout; and
generating a final layout based on the second error data.

2. The layout designing method of claim 1, wherein predicting the second error data comprises:
normalizing coordinate data of the second layout to obtain second coordinate data;
generating, using the structural analysis mesh model, second stress distribution data by performing a finite element analysis simulation, wherein the boundary condition of the structural analysis mesh model is determined based on the second coordinate data; and
generating, using the error prediction machine learning model, the second error data based on the second coordinate data and the second stress distribution data.

3. The layout designing method of claim 2, wherein the first coordinate data and the second coordinate data are normalized to a same dimension.

4. The layout designing method of claim 1, wherein generating the final layout comprises:
computing a correction value based on the second error data; and
combining the correction value to the second layout.

5. The layout designing method of claim 1, wherein generating the error prediction machine learning model comprises:
performing a Gaussian process regression (GPR) using a multi-kernel function.

6. The layout designing method of claim 5, wherein generating the error prediction machine learning model comprises:
performing multi-kernel parameter optimization using a maximum likelihood estimation (MLE).

7. The layout designing method of claim 6, wherein the multi-kernel parameter optimization comprises:
iteratively performing multi-kernel parameter optimization based on an optimization score.

8. The layout designing method of claim 1, wherein the first error data further comprises:
a first error value of misalignment between the test pattern and the reference position in a first direction; and
a second error value of misalignment between the test pattern and the reference position in a second direction, wherein the second direction is perpendicular to the first direction.

9. The layout designing method of claim 8, wherein the first stress distribution data includes a first stress value measured in the first direction and a second stress value measured in the second direction.

10. The layout designing method of claim 1, wherein forming the test pattern comprises:
forming a test mold structure pattern including one or more test holes;
forming one or more test lower electrodes in the one or more test holes; and
forming one or more test opening patterns penetrating the test mold structure pattern to expose at least a portion of a side surface of the one or more test lower electrodes.

11. The layout designing method of claim 10, wherein the reference position is a distance between a center of each of the one or more test opening patterns and a center of a virtual polygon formed from centers of upper surfaces of three or more test lower electrodes adjacent to the center of each of the one or more test opening patterns.

12. The layout designing method of claim 11, wherein the first error data includes a position difference between the center of each of the one or more test opening patterns and the center of the virtual polygon.

13. A method for layout designing, comprising:
obtaining data on a test pattern formed based on a first layout;
generating, using a first error data extracting module, first error data based on the first layout and the test pattern, wherein the first error data is a value of misalignment of the test pattern from a reference position;
normalizing, using a first coordinate data extracting module, the coordinate information of the first layout to a target dimension to obtain first coordinate data;
generating, using a first stress distribution data extracting module, first stress distribution data by performing finite element simulation analysis, wherein a boundary condition of the first stress distribution data extracting module is determined based on the first coordinate data;
generating, using an error prediction machine learning model generating module, an error prediction machine learning model based on the first error data, the first coordinate data, and the first stress distribution data;
generating, using a second coordinate data extracting module, second coordinate data based on coordinate information of a second layout and normalizing the coordinate information of the second layout to the target dimension, wherein the second layout is different from the first layout;
generating, using a second stress distribution data extracting module, second stress distribution data by performing finite element simulation analysis, wherein a boundary condition of the second stress distribution data extracting module is determined based on the second coordinate data; and
predicting, using a second error data predicting module, second error data of the second layout based on the second coordinate data and the second stress distribution data.

14. The layout designing method of claim 13, wherein generating the error prediction machine learning model comprises:
performing, using the error prediction machine learning model generating module, a Gaussian process regression (GPR) using a multi-kernel function; and
performing multi-kernel parameter optimization using a maximum likelihood estimation (MLE).

15. A method for manufacturing an integrated circuit device, comprising:
disposing a mold structure on a substrate;
penetrating the mold structure to obtain a plurality of holes;
forming a plurality of lower electrodes filling the plurality of holes;
forming a plurality of opening patterns penetrating the mold structure in a third direction perpendicular to the substrate based on a final layout of a layout design;
forming a dielectric layer covering the plurality of opening patterns; and
forming an upper electrode filling the plurality of opening patterns on the dielectric layer,
wherein the layout design comprises:
constructing an error prediction machine learning model by performing a finite element analysis simulation on a first layout; and
generating, using the error prediction machine learning model, the final layout based on a second layout, wherein the second layout is different from the first layout.

16. The method for manufacturing the integrated circuit device of claim 15, wherein constructing the error prediction machine learning model comprises:
forming a test pattern based on the first layout;
generating first error data based on the test pattern, wherein the first error data includes a value of misalignment of the test pattern from a reference position;
generating, using a structural analysis mesh model, first stress distribution data by performing a finite element analysis simulation, wherein a boundary condition of the structural analysis mesh model is based on the first layout;
generating an error prediction machine learning model based on the first error data and the first stress distribution data;
predicting, using the error prediction machine learning model, second error data based on the second layout; and
generating the final layout based on the second error data.

17. The method for manufacturing the integrated circuit device of claim 16, wherein forming the test pattern comprises:
forming a test mold structure pattern including a plurality of test holes;
forming a plurality of test lower electrodes filling the plurality of test holes; and
forming a plurality of test opening patterns penetrating the test mold structure pattern to expose at least a portion of a side surface of the plurality of test lower electrodes, and
wherein generating the first error data comprises:
computing a position difference between a center of each of the plurality of test opening patterns and a center of a virtual polygon formed from centers of upper surfaces of three or more test lower electrodes adjacent to the center of each of the plurality of test opening patterns.

18. The method for manufacturing the integrated circuit device of claim 16, wherein predicting the second error data comprises:
generating, using a structural analysis mesh model, second stress distribution data based on the second layout by performing a finite element analysis simulation; and
predicting the second error data based on the second stress distribution data.

19. The method for manufacturing the integrated circuit device of claim 18, wherein the first stress distribution data is obtained by normalizing coordinate information of the first layout to a target dimension, and
the second stress distribution data is obtained by normalizing coordinate information of the second layout to the target dimension.

20. The method for manufacturing the integrated circuit device of claim 15, wherein a center of each of the plurality of opening patterns overlaps a center of a virtual polygon formed from centers of upper surfaces of three or more lower electrodes adjacent to the center of each of the plurality of opening patterns.
